(19) United States
(12) Patent Application Publication
(10) Pub. No.: US 2002/0111970 A1
(43) Pub. Date: Aug. 15, 2002

(54) Method of displaying information in stages

(75) Inventors: Shiro Saito, Tokyo (JP); Ryosuke Harada, Tokyo (JP); Yoshiki Kimoto, Tokyo (JP); Tomomi Tsubota, Tokyo (JP)

Correspondence Address: BURR & BROWN, PO BOX 7068, SYRACUSE, NY, 13261-7068, US

(73) Assignee: Nihon Keizai Shimbun Inc., Chiyoda-Ku (JP)

(21) Appl. No.: 10/010,726

(22) Filed: Dec. 7, 2001

(30) Foreign Application Priority Data
Feb. 9, 2001 (JP) 2001-34060

(51) Int. Cl. G06F 15/00

(52) U.S. Cl. 707/517

(57) ABSTRACT

In a user interface displayed on the user's terminal device, a newspaper page image is maintained as it is while only information that is necessary to a user can be read through. Only readable headline information from a newspaper page is displayed as electronic data just as it is laid out on the newspaper page, and article information that is linked to the headline information is displayed on a display device as readable display data at a time when the readable headline information is designated selectively.

### BACKGROUND OF THE INVENTION

1. Field of the Invention

The present invention relates to a technology for displaying in stages information received by a terminal device through a network.

2. Description of the Related Art

Distribution of information through the Internet has become common, and it has become possible for a user to access a server of a newspaper company and read conventional newspaper article information, too.

Incidentally, for the reading of this type of newspaper article information it used to be common that the article information was converted into text code, images were converted to image information called GIF or JPEG and these were displayed in a text format called HTML by means of a browser program installed on the user s terminal.

Accordingly, on servers of each newspaper company, the user has been provided texts, photograph images and advertisement images rearranged on a different layout on the general newspaper page.

However, as described above, different information layouts are used for the newspaper pages which are to be delivered and the article information which is to be read on the Internet; therefore, according to the current state of the technology the reader must be conscious of this different information layout when reading the article information on the server, and the technology for effective article information layout on newspaper pages, which were developed over many years, could not be utilized for the network distribution.

Accordingly, by making the entirety of pages in the newspaper readable from the sever as image information, it is assumed to provide the information to the user in the layout formats of article information as newspaper itself, however the amount of data for converting the entirety of the page into image information becomes greater than that of converting into character information, it is not practical for a user connecting to the network via low-speed public lines to take a lot of time to download the article information to terminal device.

The present invention is developed to solve problems such as those described above. The present invention provides a display technology, in a user interface displayed on the user's terminal device, for displaying in stages the article information in the condition of the page image in newspaper being maintained, so that the user can read only the article which necessary information is contained.

### SUMMARY OF THE INVENTION

According to the present invention, only readable headline information from a newspaper page is displayed as electronic data just as it is laid out on the newspaper page; and article information that is linked to the headline information is displayed on a display device as readable display data when the readable headline information is selectively designated by the user.

Generally, for a reader who is reading a newspaper page that is distributed on a paper medium, it is common that the reader first looks over the headlines on the page while reading only the articles in which he or she is interested.

According to the present invention, in order to realize, even on a network distribution system, this kind of reading process which is performed by the reader on such the paper medium, the headline information is first displayed on the terminal, just as they are laid out on the newspaper page. Then, in the case that any of the headline information is selected by clicking on a mouse, the detailed article (the article information) of that headline information is displayed as readable display data.

Accordingly, the server first distributes, to the terminal device, only the headline information is arranged on the newspaper page so-called skeleton newspaper. This skeleton newspaper is comprised of image data, but in its substance only the headline information is real data, so the distributed data has much less volume than the distributed image data which turned all the newspaper article into, and it is possible to display the headline information without stress even on a user terminal connected to low-speed public lines.

Also, a user operating a user terminal is let to read the pages only through the headline information and when a headline information interested among this clicked with a mouse and the like by the user, the detailed article information which is linked to that headline information is displayed.

In other words, the volume of information to be sent does not become great even at this stage so that the server distributes to the terminal device only the article information corresponding to the headline information desired by the user.

The article information distributed at this time may be code information encoded as a character line, or may be image data in which the article content has been turned into an image.

Further, displaying the characters and the background screen with color differentiation in-article units produces an effect the article type can be easily distinguished visually.

The present invention enables the display of article information in stages in a user interface displayed on the user's terminal device, in which a newspaper page image is maintained as it is while only information that is necessary to a user can be read through.

### BRIEF DESCRIPTION OF THE DRAWINGS

In the accompanying drawings:

FIG. 1 is a system construction diagram illustrating one embodiment of the present invention.

FIG. 2 is a flow chart illustrating an order of displaying a user's display screen of one embodiment.

FIG. 3 is a login screen of one embodiment.

FIG. 4 is a selection screen of a newspaper page of one embodiment.

FIG. 5 is an example of a screen display of skeleton data.

FIG. 6 is an example of a display of article information in page units.

FIG. 7 is an example of a display of the article information in article units.

FIG. 8 is a diagram of explanation illustrating a method of distinguishing an partition of area of articles.

FIG. 9 is an example of a display of the article information by means of a character code in article units.

### DETAILED DESCRIPTION OF THE PREFERRED EMBODIMENTS

Hereinafter, explanation will be made of an embodiment of the present invention based on the drawings.

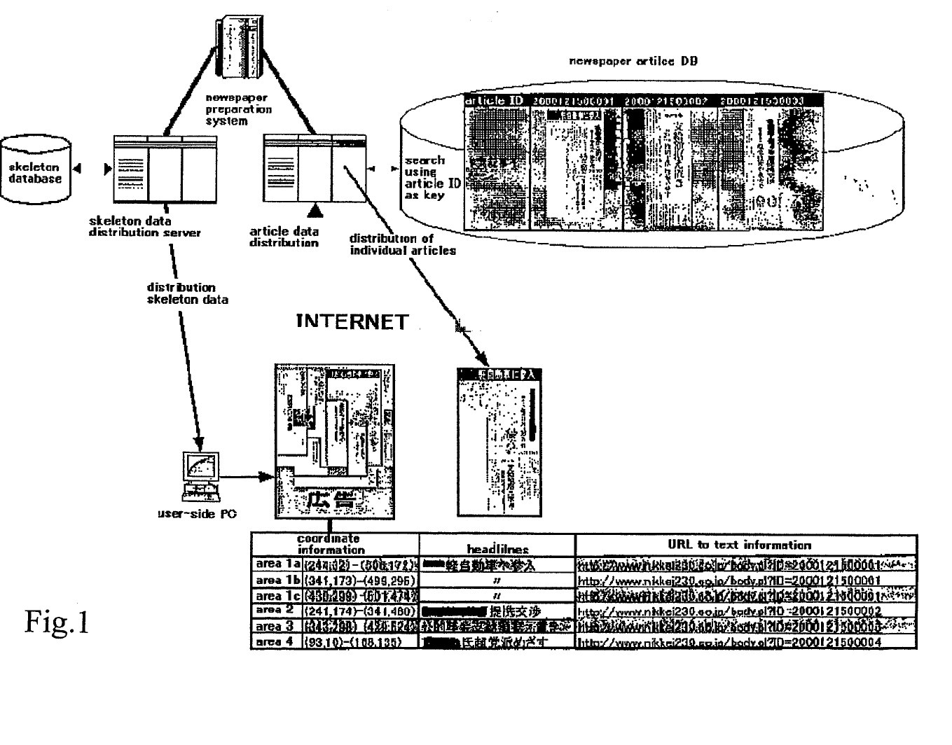

FIG. 1 is a system construction diagram of one embodiment of the present invention.

The present embodiment is composed of a skeleton data distribution server connected to a newspaper preparation system, and an article data distribution server. These two servers are connected to a user terminal (a user-side PC) through the Internet or other such general-purpose network.

In the present embodiment, the process of displaying information in stages is realized by means of the cooperation between the skeleton data distribution server and the article data distribution server, and is controlled by programs installed into each of the servers. The program can be stored in a storage medium such as a CD-ROM or a hard disk device, for example.

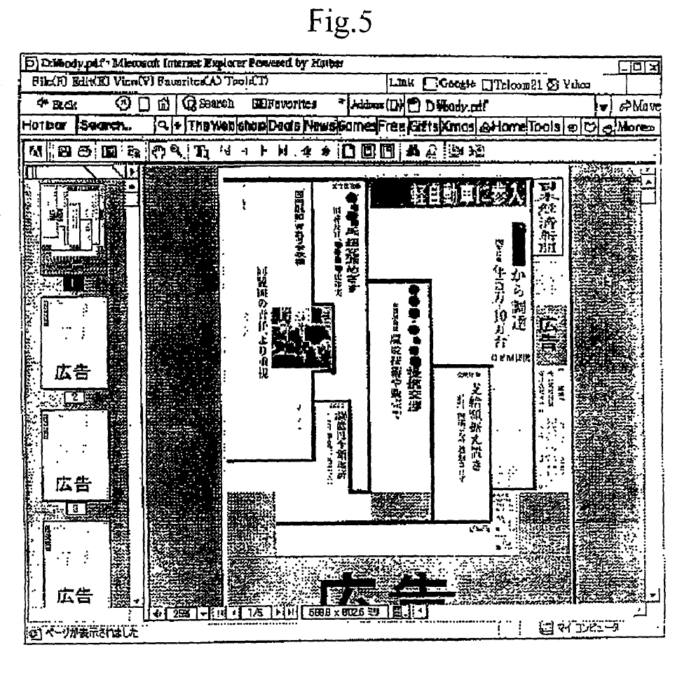

The skeleton data distribution server has a database, and image file data (the skeleton data such as shown in FIG. 5) in which only the headline information of the newspaper pages has been turned into electronic data just as it was laid out on the newspaper pages is accumulated. This image field data can be realized in the PDF format produced by Adobe, or in a general-purpose image data format such as JPEG or GIF format, for example.

This type of image file data composed of headline information may be created from character code, which is to become the characters of a headline as being the file attribute, and an intermediate file from the newspaper article preparation system in which there is contained a font designation value and headline designation information.

When the skeleton distribution server receives the intermediate file from the newspaper article preparation system, it reads the value designated in the file for the character font, recognizes characters having a designated font of a certain size or larger and characters having the headline designation information as being headline information, and generates skeleton data composed of this headline information and a frame diagram.

In this skeleton data, headlines and the coordinates information for each headline information are linked to an address (URL, or Uniform Resource Locator) of the article information (the article text information). This link may be stored as a table structure in an image file, or it may be downloaded to the user terminal as other files separately from the skeleton data.

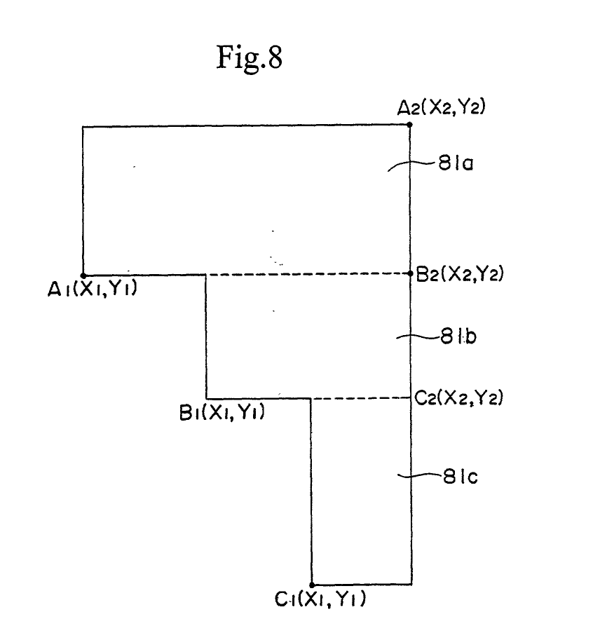

The areas of the articles including the headline information are constructed on a newspaper page with a complex rectangular shaped areas marked off by horizontal and vertical lines, but it is possible to define coordinates for all of these by considering them as combinations of squares. For example, for defining an article area as shown in FIG. 8, it is divided into three squares, and the coordinates of the lower left and upper right of each square are defined respectively (A1:A2, B1:B2, C1:C2), thereby defining the area of this article.

Then, by tracing the largest value and smallest value of the xy coordinates which satisfy these conditions, it becomes possible to generate and display demarcation lines defining the outer frame of this article. Displaying the outer frame of an article in this way enables the user to understand the proportion that the article occupies on the page, and it becomes easy to determine whether the article is an important article or not.

Further, a configuration is also possible in which the article classifications (ex, classification into events, industry and economics) are defined per each article area inside the demarcation lines, and these may be displayed on the user terminal with color differentiation per classification.

With this technology of differentiating the article classifications by color in this way, it is possible to use the headline information to perform text matching at the skeleton data distribution server, setting the color corresponding to the attributes of the information in advance. For example, when the term “automobile” is included, this receives the color differentiation for “industry” or “economics,” and when the term “government regime” is included, this receives the color differentiation for “politics.”

Further, although there is a color differentiation method in which the letters themselves are displayed with color differentiation, it is also possible to color differentiate only the background screen within the demarcated area of the given article.

When any point of the article area containing headline information is designated by means of a mouse or other auxiliary input device, the headline corresponding to this coordinate and the URL corresponding to this headline information (ex, http://www.nikkei230.co.jp/body.p!?ID=2000121500001) are read out, and access is made to the article data distribution server via this URL. The article data distribution server has a newspaper article database, and the article information corresponding to the article ID contained in the URL is read out from the newspaper article database.

Then, the article information is read out from the article data distribution server and downloaded to the user terminal. At the user terminal the file of the article information downloaded in this way is displayed by means of a browser program such as Internet Explorer of Microsoft Corporation or Netscape Navigator of Netscape Communications Corporation.

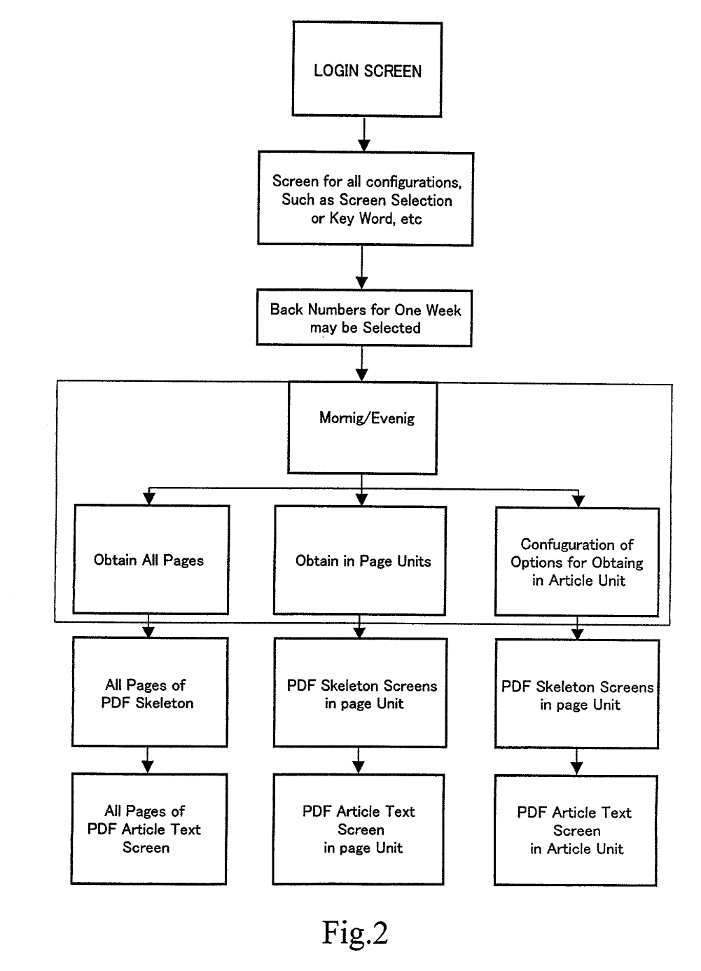

Next, explanation will be made of an order for displaying the headline information and the article information on the user terminal, making reference to FIG. 2 through FIG. 7.

FIG. 2 is a block diagram depicting processing from a login screen to display of the article information.

First, the user boots a communications application on the user terminal, and after that boots the browser program, designates a predetermined URL (i.e., the URL of the skeleton data distribution server, such as http://www.nikkei230.co.jp)

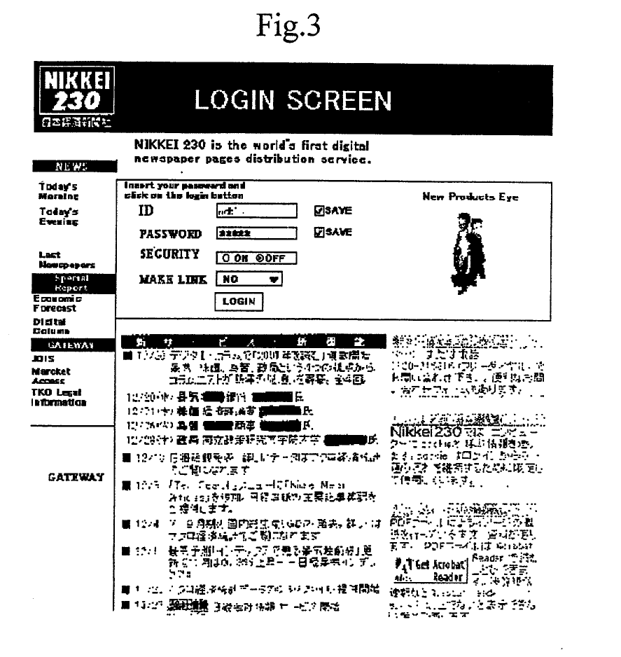

The server sends the login screen depicted in FIG. 3 to the user terminal, and requests input of a user ID and password.

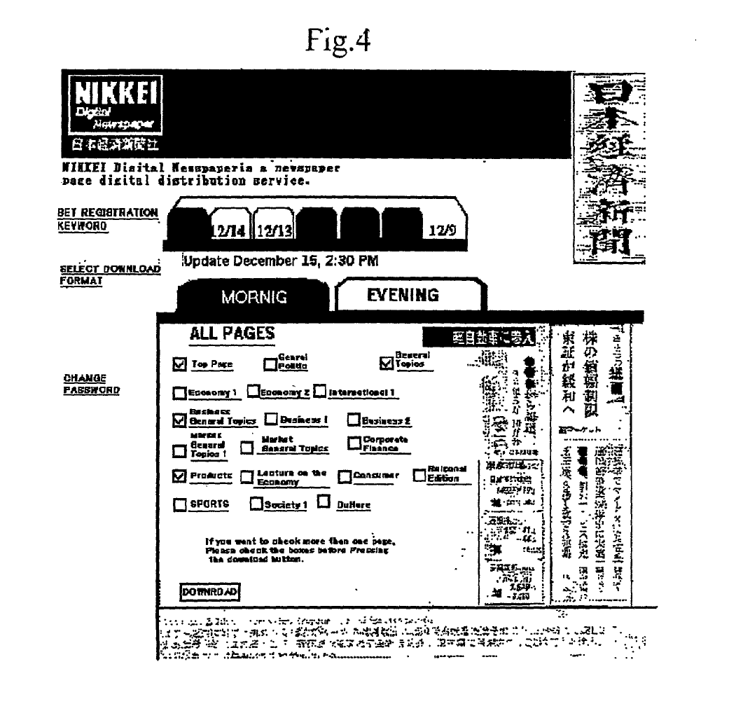

When the login is completed, an article selection screen depicted in FIG. 4 is displayed. In the same diagram, it is possible to select a daily morning edition or evening edition by checking a check box for the pages which the user desires to obtain. This check can actually be performed by a left-click with the mouse and the like. In the same diagram, front page, a general topics page, a business general topics page, a business finances page, a products page and a regional editions page are selected respectively.

Next, when a “download” button provided on the bottom-left of the screen is designated, the downloading of the skeleton data for the screens designated as stated above begins.

FIG. 5 displays an example of a screen display of skeleton data downloaded to the user terminal screen.

As shown in the same diagram, only the headline article is composed of image data being the real data, and no data exists in the areas where the text is printed on the normal newspaper page. Therefore, even though this is composed of image data, the total volume of the skeleton data may be suppressed extremely small.

By downloading the skeleton data of the designed screens (front page, the general topics page, the business general topics page, etc.) to the user terminal and designating a button on the browser for flipping through pages as shown in FIG. 5 (i.e., the left-pointing triangular button in the information of the same diagram), it thus becomes possible to read the headline information, going from the front page to the general topics page to the business general topics page, just like flipping through newspaper of a paper medium.

Next, when the user wants to read the article information the text itself) based on the headline information, the user designates any single point in the designated area of the article displayed on the user terminal with the mouse. Based on designated coordinates for this area, the corresponding table explained in FIG. 1 is read out, and the URL containing the corresponding article information (the text) ID are read out.

The user terminal accesses the article data distribution server based on this URL. The article data distribution server accesses the newspaper article database based on the instructed ID, and the article information is read out and distributed to the user terminal.

The newspaper article database is capable of registering newspaper article data in various data formats.

The first of these formats is one in which the newspaper articles are newspaper article data accumulated as image data having an ID per newspaper page attached thereto.

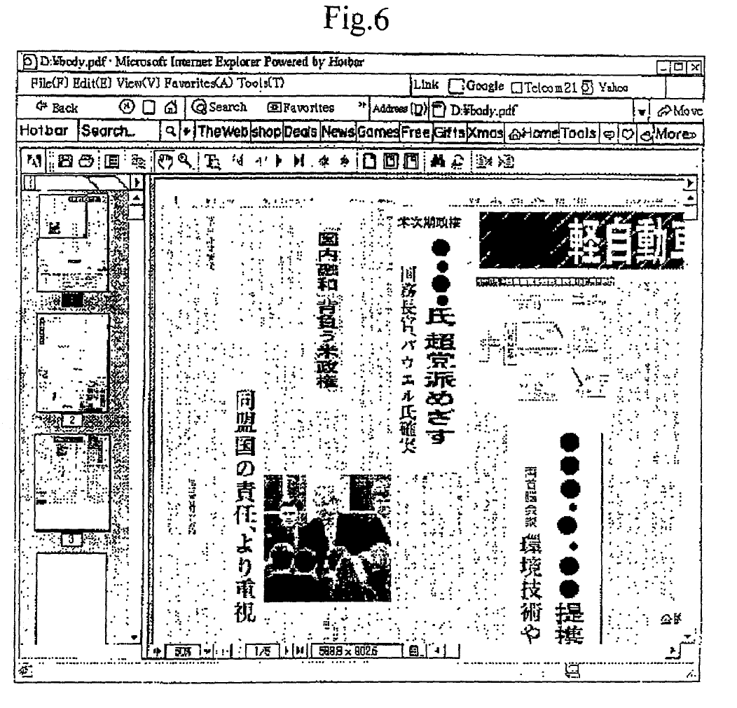

In this case, all of the image data of the page containing the article information is distributed to the terminal device by means of the article ID linked to the headline information. FIG. 6 displays an example of this, and designation of any of the headline information depicted in FIG. 5 produces a result that the screen containing that headline information, namely the entire article information of the skeleton data shown in FIG. 5, is displayed on the user terminal device.

The second of these formats is one for accumulating newspaper article data as image data to which an ID has been given per article of the newspaper as a newspaper article.

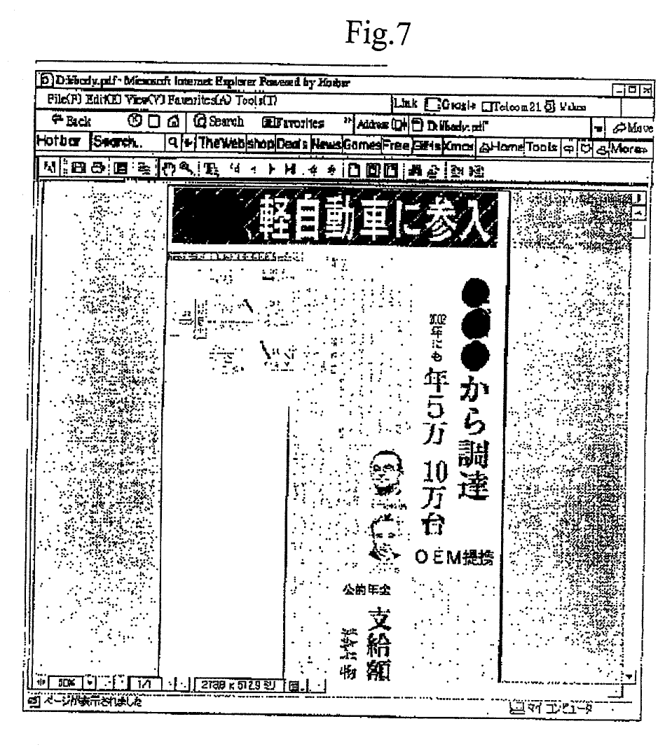

In this case, the only article information that is sent to the terminal device is the article information which corresponds to the headline information by virtue of the article ID which has been linked to the headline information. FIG. 7 is a diagram depicting an example of this. That is, designating headline information of the top article shown in FIG. 5 produces the result that the article information (the text) corresponding to this headline information is displayed on the user terminal device.

The third of these formats is one for accumulating newspaper article data as character code data to which an ID has been given per article of the newspaper as a newspaper article.

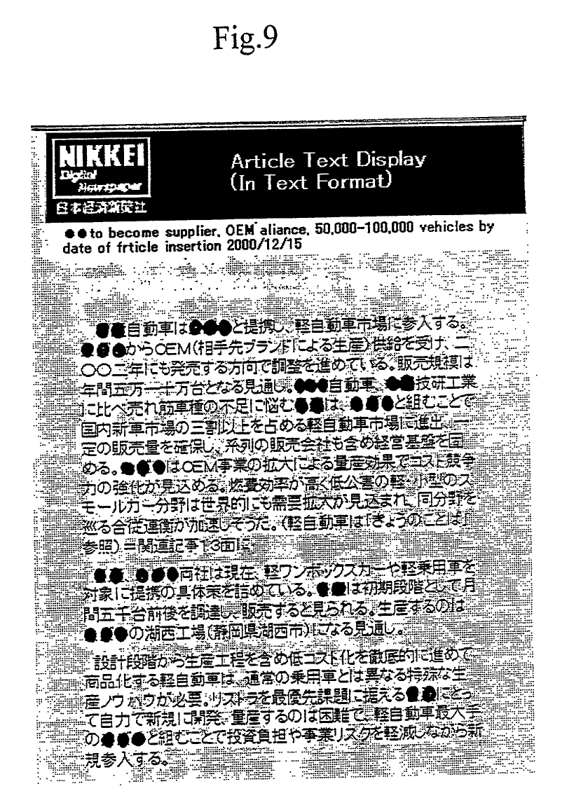

In this case, as shown in FIG. 9, the article information corresponding to the headline information is displayed on the user terminal device in a status configured in HTML format.

Note that, in the embodiment, explanation was made using an example in which the skeleton data is received, and thereafter, the designated article information is downloaded from the article data distribution server. However, the present invention is not limited thereto, and it is also possible for the skeleton data and the article data to be stored in a high-capacity storage medium such as a CD-ROM or such and installed into the hard disk device of the user's personal computer.

Even in a case that the network is not used, it is possible to search the article effectively so that the skeleton data is able to be read through as an index of each article.

Further, the display technology of color differentiation per article classification explained in the present embodiment is not only limited to display article information in stages, for example, but this technology can also be applied to be downloaded and displayed the newspaper article in page units. In this case the newspaper article is obtained in page units, but it is displayed on the user terminal according to color differentiation by article classification, thereby it has also a visual effect for the user to easily recognize the type of the article imaginatively.

What is claimed is:

1. A method of displaying information in stages, comprising the steps of:
displaying as electronic data only readable headline information from a newspaper page just as it is laid out on the newspaper page; and
displaying article information linked to the headline information on a display device as readable display data, when the readable headline information is selectively designated.

2. A method according to claim 1, wherein the article information is comprised of a character code line.

3. A method according to claim 1, wherein the article information is image data that a character code line is displayed as an image.

4. A method of distributing information in stages to be executed by a server, comprising the steps of:
distributing from the server to a terminal device only readable headline information from a newspaper page as electronic data just as it is laid out on the newspaper page;
receiving a selection of any of the headline information in the electronic data displayed on the terminal device; and
distributing the article information linked to the selected headline information to the terminal device.

5. A method according to claim 4, wherein the article information is composed of a character code line.

6. A method according to claim 4, wherein the article information is image data in which a character code line is displayed as an image.

7. A method of distributing information in stages to be executed on a terminal device, comprising the steps of:
displaying only readable headline information from a newspaper page as electronic data just as it is laid out on the newspaper page;
receiving a selection of any of the headline information in the electronic data displayed on the terminal device;
reading out the article information linked to the selected headline information; and
displaying the article information which has been read out.

8. A method according to claim 7, wherein the article information is composed of a character code line.

9. A method according to claim 7, wherein the article information is image data in which a character code line is displayed as an image.

10. A method of distributing information in stages executed by the server according to claim 4, wherein all of the article in the newspaper are linked to headline information, comprising the step of distributing all of the article information in the newspaper included the headline information to terminal device when any of the headline information is selected.

11. A method of distributing information in stages executed by a server according to claim 4, wherein all the articles in the page containing that newspaper headline are linked to the headline information, and which comprises the step of distributing, when any of the headline information on that page is selected, the article information of all the articles of that page that includes the selected headline information to the terminal device.

12. A method of distributing information in stages executed by a server according to claim 4, wherein an electronic data distributed from the server to the terminal device includes readable headline information and line-drawing information indicating partition of arrangement on the paper the headline information belonging to.

13. A method of distributing information in stages executed by a server according to claim 12, wherein the inside of each partition for arrangement is indicated with colors according to the sort of the article information identified by the readable headline information.

14. A computer readable storage medium storing a program for making a server execute the steps of:
distributing from the server to a terminal device only readable headline information from a newspaper page as electronic data just as it is laid out on the newspaper page;
receiving a selection of any of the headline information in the electronic data displayed on the terminal device; and
distributing the article information linked to the selected headline information to the terminal device.

15. A program for making a server execute in stages the steps of:
distributing from the server to a terminal device only readable headline information on a newspaper page as electronic data just as it is laid out on the newspaper page;
receiving a selection of any of the headline information in the electronic data displayed on the terminal device; and
distributing the article information linked to the selected headline information to the terminal device.
